(19) United States
(12) Patent Application Publication
(10) Pub. No.: US 2003/0178486 A1
(43) Pub. Date: Sep. 25, 2003

(54) Mobile memory card reader and a fixing base thereof

(75) Inventors: Wei Kuang Teng, Taipei (TW); Che-Wen Lin, Taipei (TW)

Correspondence Address: BRUCE H. TROXELL, SUITE 1404, 5205 LEESBURG PIKE, FALLS CHURCH, VA, 22041, US

(73) Assignee: POWER QUOTIENT INTERNATIONAL CO., LTD.

(21) Appl. No.: 10/117,125

(22) Filed: Apr. 8, 2002

(30) Foreign Application Priority Data
Mar. 20, 2002 (CN) 02204142.7

(51) Int. Cl. G06K 7/06; G06K 7/08

(52) U.S. Cl. 235/441

(57) ABSTRACT

A fixing base for a card reader is built in a read and write apparatus frame in a personal computer to be in company with a mobile memory card reader. The mobile memory card is further associated with a USB to perform a function of detachable hot insertion and multiple node series so as to design an application of circuit connection and a composite structure.

### BACKGROUND OF THE INVENTION

1. Field of the Invention

The present invention relates to a mobile memory card reader and a fixing base thereof.

2. Description of Related Art

Due to the technology of personal computer changes rapidly, it makes the current personal computer not only provides a much more powerful operation function but also is capable of connecting much more peripheries such as the key board, the scanner, the printer, and the memory card reader, etc. Of course, it is necessary for these peripheries to connect with the personal computer by way of certain data transmission interfaces while in use. Many peripheries sold in the market have adopted the USB as the data transmission interface and, for instance, the memory card reader is a typical example using the USB.

Usually, the USB socket is arranged at the rear side of the computer case or attached to the main board in the case so that it is necessary for the peripheries to connect with the main unit of the personal computer by way of an extension line with a length of several times of ten centimeters. It is inconvenient for a user to carry a small sized memory card reader and the extension line with him after data from the digital still camera (DSC) or the personal digital assistant (PDA) being saved in a memory card. Hence, to develop a portable card reader to benefit the user is quite essential for a supplier.

Accordingly, how to utilize the feature of the product adequately in company with considering the operation habit of the user so as to enhance the added value for the product is a subject matter worth to be cared by the manufacture.

### SUMMARY OF THE INVENTION

The crux of the present invention resides in that a fixing base for a card reader is built in a read and write apparatus frame in a personal computer to be in company with a mobile memory card reader. The mobile memory card is further associated with a USB to perform a function of detachable hot insertion and multiple node series so as to design an application of circuit connection and a composite structure.

### BRIEF DESCRIPTION OF THE DRAWINGS

The present invention can be more fully understood by reference to the following detailed description and accompanying drawings, in which:

FIGS. 1 is a perspective view of a fixing base for a memory card reader according to the present invention;

FIG. 2 is a perspective view illustrating the fixing base shown in FIG. 1 being installed in a personal computer;

FIG. 3 is a perspective view illustrating the mobile memory card reader of the present invention being mounted in the fixing base shown in FIG. 1;

FIGS. 4A and 4B are perspective views of the mobile memory card reader being projected onto the front side and the lateral side thereof respectively;

FIG. 5 is a perspective view illustrating the interior of the fixing base for the mobile memory card reader of the present invention; and

FIG. 6 is a block diagram illustrating electrical connection lines applied in the present invention.

### DETAILED DESCRIPTION OF THE PREFERRED EMBODIMENTS

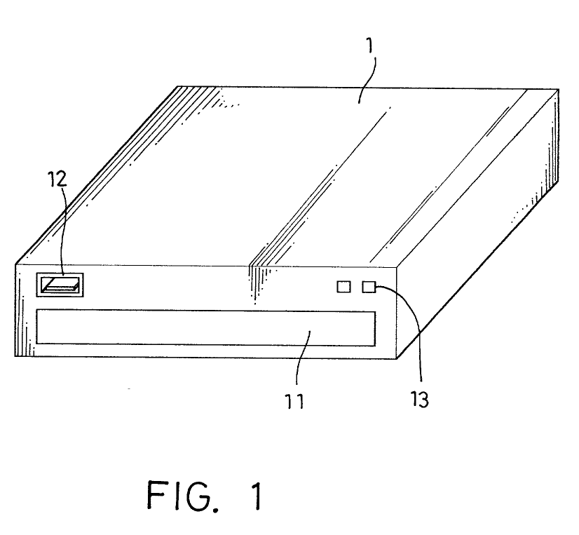

In order to explain the key concept of the present invention, please refer to FIG. 1 first. A fixing base for a memory card reader of the present invention, which is built in a personal computer, is shown with a shape of rectangular box. The fixing base is designated as a containing box 1 hereinafter. The containing box 1 has a front panel, which includes a reader receiving groove 11, a USB wire collector 12 and at least an indicator light 13. The present inventor has designed the containing box 1 to be installed in one of reserved spaces of the read and write device frame at the front side of the personal computer. Therefore, the containing box 1 can be installed in the space.

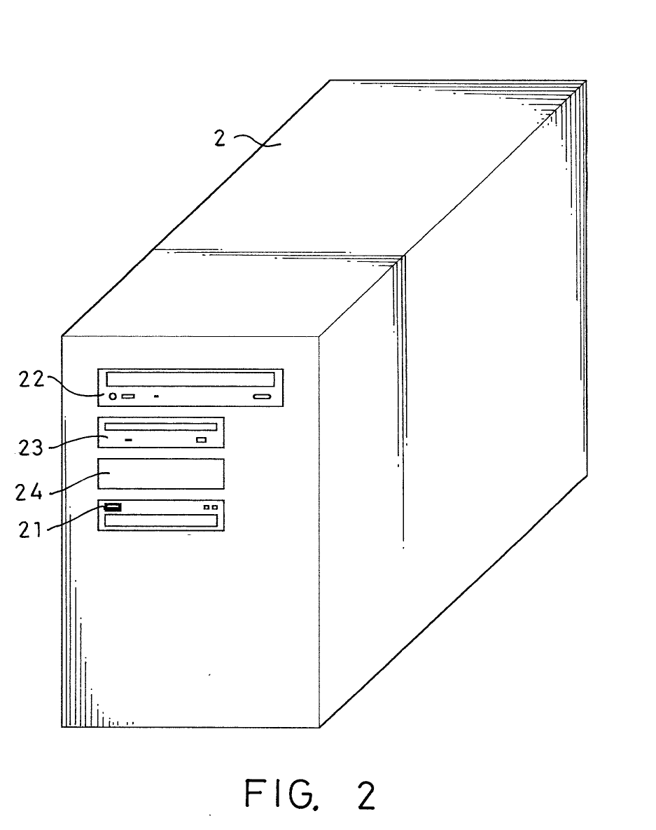

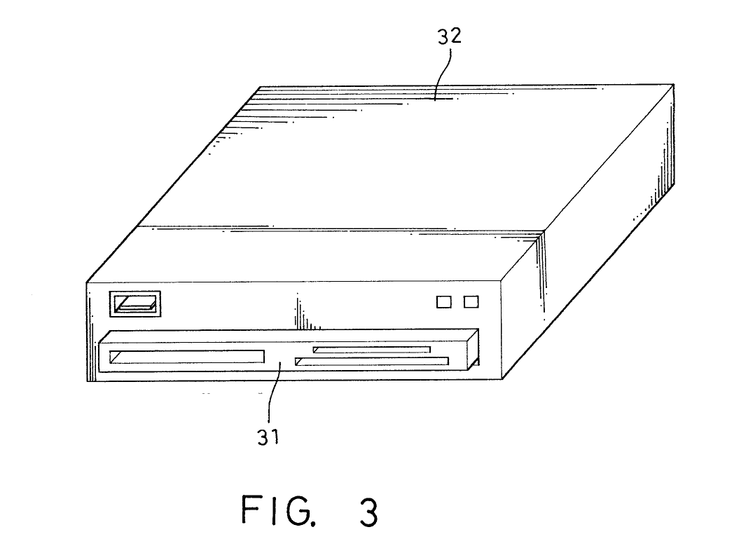

Referring to FIG. 2, an example for the containing box in practice is illustrated. It can be seen that the containing box 21 has been inset to the read and write apparatus frame together with a compact disk driver 22, a floppy disk driver 23 and a hard disk 24. Then, a mobile memory card reader can be inserted into the receiving groove 11. Referring to FIG. 3, a combined structure of a mobile memory card reader 31 and a containing box 31 is illustrated. It can be seen that the detachable memory card reader 31 is fixed to the personal computer at the front panel thereof so that the user is capable of easily inserting a memory card into the card reader through a slot socket facing to him directly and it is not necessary to provide an extension line any more. Therefore, the present invention can enhance the portability of the memory card reader greatly.

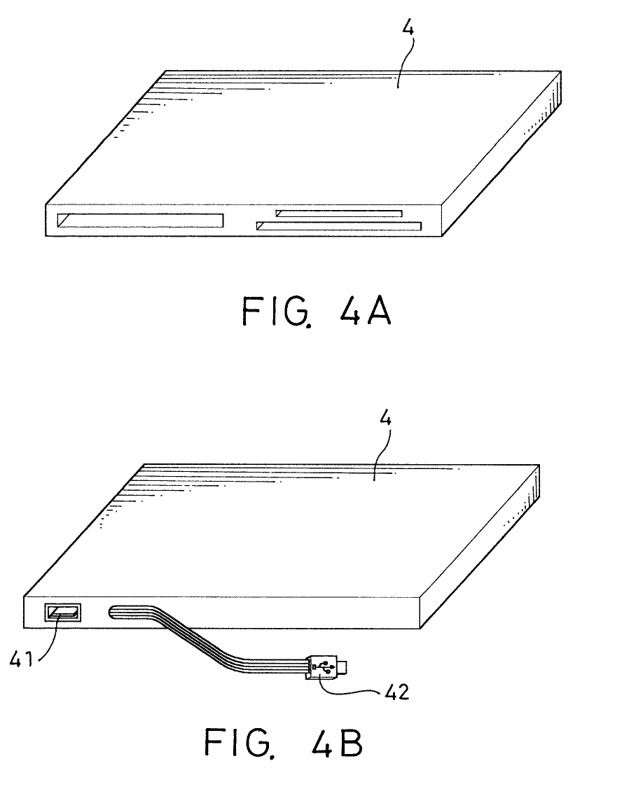

Referring to FIGS. 4A and 4B, the mobile memory card reader at the facial side thereof provides a plurality of inserted slots for different types of memory cards such as the compact flash card (CF), the smart media card (SMC), the multimedia card (MMC), the secure digital card (SD), the memory stick (MS), the micro drive and the smart card. These different types of memory cards may be inserted into the inserted slots one at a time and the arrangement of the inserted slots being located at the facial side of the memory card reader 31 is helpful for the stability of memory card during being inserted and taken out.

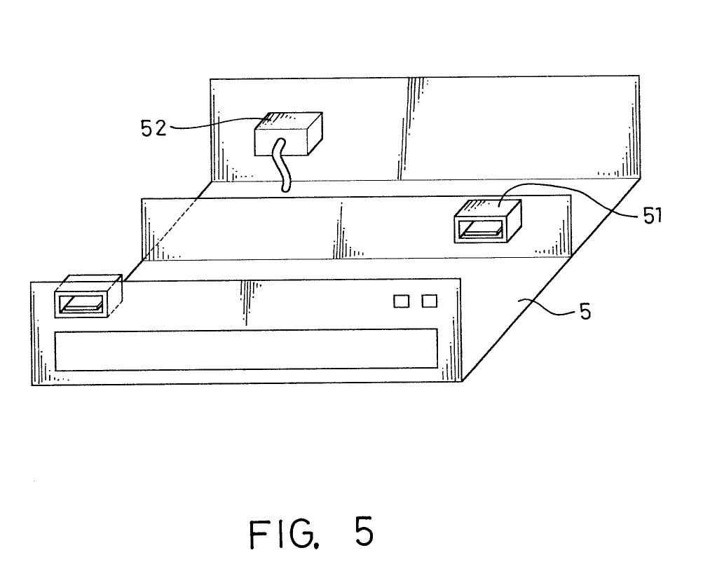

The mobile memory card reader 4 at the interior thereof has printed circuit board and related electronic parts and at the rear side thereof has a bus socket 41. The bus socket 41 is corresponding to a bus plug 51 on the fixing base 5 shown in FIG. 5 so that the bus plug 51 can engage with the bus socket 41 at the time of the card reader 4 being received in the fixing base 5 to constitute an electrical connection. Further, a USB socket 52 shown in FIG. 5 can be connected to a USB socket in the personal computer by way of an extension line such that the function of multiple node connections in series for the USB can be performed advantageously.

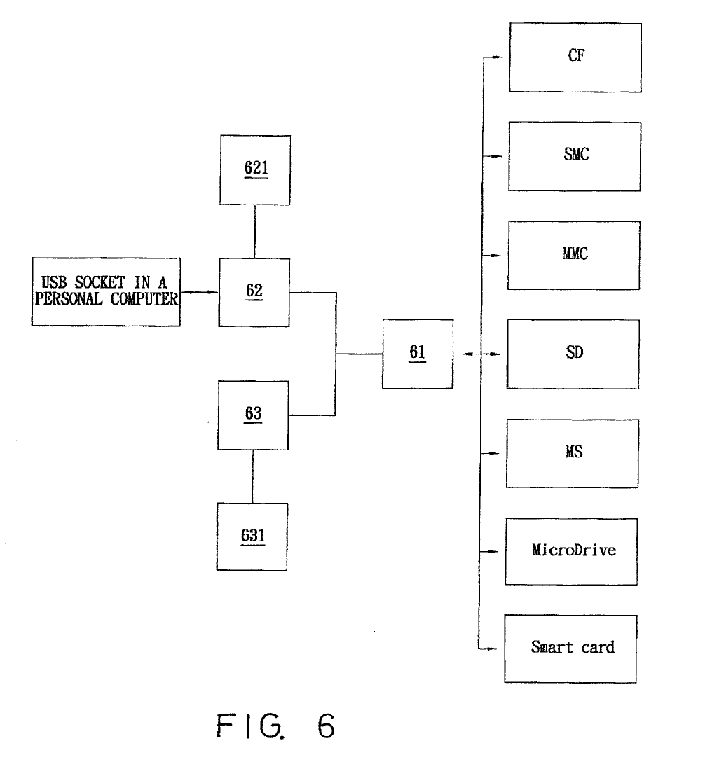

Finally, referring to FIG. 6, a control chip 61 of the card reader, a control chip 62 of the wire collector in the USB and a control circuit 63 of the indicator light can form a circuit as soon as the mobile memory card reader is placed in the fixing base. Hence, once the control chip 61 of the card reader processes to read data from or write data into the memory card, the control circuit 63 of the indicator light can control the indicator light 631 to assist the user in understanding that the status of the mobile memory card reader is in a state of reading or writing. The control chip 62 of the wire collector in the USB further has a wire collector socket 621 to be connected to other periphery directly by the user conveniently in addition to data transmission between the mobile memory card reader and the personal computer such that it is not necessary to use an extension line being connected to the rear side of the personal computer.

It is appreciated that the mobile memory card reader with a fixing base thereof according to the present invention has involved in multiple distinctive designs substantially improved the disadvantage of conventional flash memory disk module greatly.

While the invention has been described with reference to a preferred embodiment thereof, it is to be understood that modifications or variations may be easily made without departing from the spirit of this invention, which is defined by the appended claims.

What is claimed is:

1. A mobile memory card reader, comprising:
a casing, at an interior thereof being arranged with a printed circuit board and a plurality of electronic parts;
a USB plug, being located at a rear side of the casing to connect with a USB socket in a personal computer;
a bus socket, being disposed at the rear side of the casing to connect with a reader fixing base built in the personal computer; and
at least a slot socket, being arranged at a front side of the casing for being inserted with a memory card.

2. The mobile memory card reader according to claim 1, wherein the slot socket is used for being inserted with a CF card, a SMC card, a MMC card, a SD card, a MS card, a micro-drive or a smart card.

3. A fixing base for a card reader being built in a personal computer, comprising a containing box with a panel, being fixedly attached to a read and write apparatus frame of a personal computer;
a card reader receiving groove, being received at the panel and providing a space for being inserted with a mobile memory card reader;
a bus plug, being disposed in the containing box to connect with the mobile memory card reader; and
a USB socket, being disposed at a rear side of the containing box to connect with a USB socket in a personal computer by way of an extension line so that signal connection can be formed.

4. The fixing base for a card reader according to claim 3, wherein the bus plug in said containing box corresponding to and being connected to the bus socket at the rear side of the casing.

5. The fixing base for a card reader according to claim 3, wherein a USB wire collector socket is provided at the panel of the containing box.

6. The fixing base for a card reader according to claim 3, wherein the panel at least includes an indicator light.
